(19) United States
(12) Patent Application Publication
(10) Pub. No.: US 2007/0179658 A1
(43) Pub. Date: Aug. 2, 2007

(54) SUBSTRATE PROCESSING SYSTEM CAPABLE OF MONITORING OPERATION OF SUBSTRATE PROCESSING APPARATUS

(76) Inventor: Tetsuya HAMADA, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/670,018

(22) Filed: Feb. 1, 2007

(30) Foreign Application Priority Data
Feb. 1, 2006 (JP) JP2006-024564

(51) Int. Cl. G06F 19/00

(52) U.S. Cl. 700/121

(57) ABSTRACT

Operating information about an operating part for performing an operation for processing in a substrate processing apparatus is detected by a detector, and is transmitted as an operating information signal from a unit controller to a data controller. An obtaining part in the data controller accumulates such operating information signals to obtain operating state transition information indicating a change with time in operating state of the operating part, and judges whether or not the operating state transition information is abnormal. When the operating state transition information is abnormal, a warning signal indicating that the operating state of the operating part is abnormal is transmitted from the data controller to a main controller. When the main controller receives the warning signal, a warning issuing part in the main controller issues a warning indicating that there is a possibility of the occurrence of a failure in the operating part.

### BACKGROUND OF THE INVENTION

1. Field of the Invention

The present invention relates to a technique in which a monitoring controller monitors the operation of a substrate processing apparatus for performing a predetermined process upon a substrate such as a semiconductor substrate, a glass substrate for a liquid crystal display device, a glass substrate for a photomask, a substrate for an optical disk and the like.

2. Description of the Background Art

As is well known, semiconductor and liquid crystal display products and the like are fabricated by performing a series of processes including cleaning, resist coating, exposure, development, etching, interlayer insulation film formation, heat treatment, dicing and the like on the above-mentioned substrate. Conventionally, such processes are performed in a substrate processing apparatus including a plurality of processing units incorporated therein. A transport robot provided in the substrate processing apparatus transports a substrate to the plurality of processing units in sequence, and each of the processing units performs a predetermined process on the substrate. Thus, a series of processes are performed on the substrate.

With the progress of rapid reduction in semiconductor design rules in recent years, the required level of the quality control of substrates has become increasingly stringent, and there has been a need to manage the processing units of the substrate processing apparatus more strictly. To meet the need, for example, Japanese Patent Application Laid-Open No. 2004-25057 discloses a system including a data collection controller provided separately from a substrate processing apparatus to thereby collect and monitor also changes with time in operating states of processing units. The provision of such a purpose-built data collection controller for monitoring the changes with time in operating states of the processing units makes it possible to predict future failures in the processing units, thereby accomplishing the more strict management of the processing units.

In such a conventional system, the above-mentioned purpose-built data collection controller analyzes the changes with time in operating states of the processing units to report the result of the analysis to a higher-level host computer or the like. If there is a possibility that a failure occurs in an operating part for a processing unit, the host computer or the like displays advance notice of the failure.

However, since the substrate processing apparatus cannot grasp information about such advance notice of the failure and the like, an operator working around the substrate processing apparatus cannot immediately recognize the advance notice of the failure to tend to be late in troubleshooting and in maintenance support. If a failure or trouble, rather than the advance notice of the future failure, actually occurs now in the operating part for the processing unit, the substrate processing apparatus issues an alarm. In other words, the collective management of information about the advance notice of failures and information about actual failures has not yet been performed in the substrate processing apparatus in the conventional system.

### SUMMARY OF THE INVENTION

The present invention is intended for a system for processing a substrate. The system comprises: a substrate processing apparatus for performing a predetermined process on a substrate; and a monitoring controller for monitoring the operation of the substrate processing apparatus, the substrate processing apparatus and the monitoring controller being connected to each other.

According to the present invention, the substrate processing apparatus in the system includes an operating part for performing an operation for the predetermined process, a detector for detecting operating information about the operating part, and a main controller for managing the operation of the operating part. The monitoring controller includes an obtaining part for obtaining operating state transition information indicating a change with time in operating state of the operating part, based on the operating information about the operating part transmitted from the detector, and a teaching part for transmitting a warning signal indicating that the operating state of the operating part is abnormal to the main controller when the operating state transition information is abnormal.

When the operating state transition information is abnormal, the warning signal indicating that the operating state of the operating part is abnormal is transmitted to the main controller of the substrate processing apparatus. This enables the substrate processing apparatus to collectively manage the information about operating anomalies in the operating part.

Preferably, the main controller includes a warning issuing part for issuing a warning indicating that there is a possibility of the occurrence of a failure in the operating part when receiving the warning signal from the teaching part.

This enables an operator working near the substrate processing apparatus to recognize a failure notice immediately, thereby allowing rapid troubleshooting and maintenance support.

The present invention is also intended for a substrate processing apparatus for performing a predetermined process on a substrate.

According to the present invention, the substrate processing apparatus comprises: an operating part for performing an operation for the predetermined process; a detector for detecting operating information about the operating part; a main controller for managing the operation of the operating part; and a monitoring controller for monitoring the operation of the substrate processing apparatus, the monitoring controller including an obtaining part for obtaining operating state transition information indicating a change with time in operating state of the operating part, based on the operating information about the operating part transmitted from the detector, and a teaching part for transmitting a warning signal indicating that the operating state of the operating part is abnormal to the main controller when the operating state transition information is abnormal.

When the operating state transition information is abnormal, the warning signal indicating that the operating state of the operating part is abnormal is transmitted to the main controller. This enables the substrate processing apparatus to collectively manage the information about operating anomalies in the operating part.

It is therefore an object of the present invention to provide a substrate processing system which enables a substrate processing apparatus to collectively manage information about operating anomalies in an operating part, and the substrate processing apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a substrate processing apparatus according to the present invention;

FIG. 2 is a front view of a liquid processing part;

FIG. 3 is a front view of a thermal processing part;

FIG. 4 is a view showing a construction around substrate rest parts;

FIG. 5A is a plan view of a transport robot;

FIG. 5B is a front view of the transport robot;

FIG. 6 is a block diagram schematically showing a control mechanism;

FIG. 7 shows the details of the management of information about an operating anomaly in an operating part; and

FIG. 8 shows an example of an alarm file.

### DESCRIPTION OF THE PREFERRED EMBODIMENTS

A preferred embodiment according to the present invention will now be described in detail with reference to the drawings.

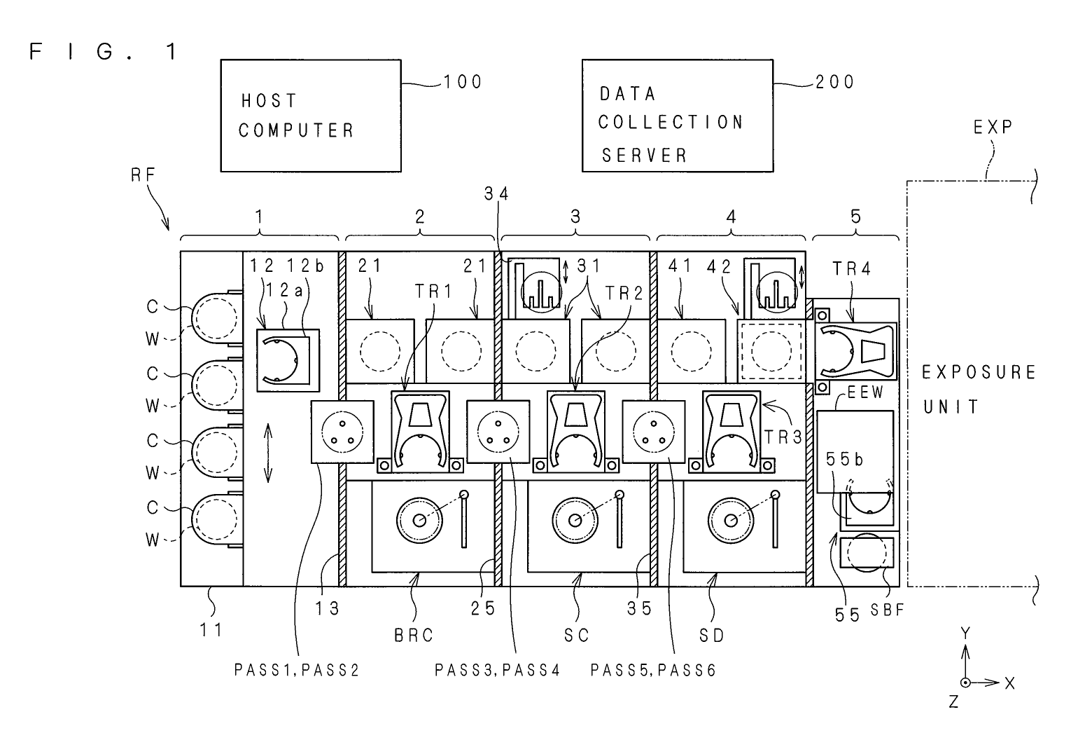

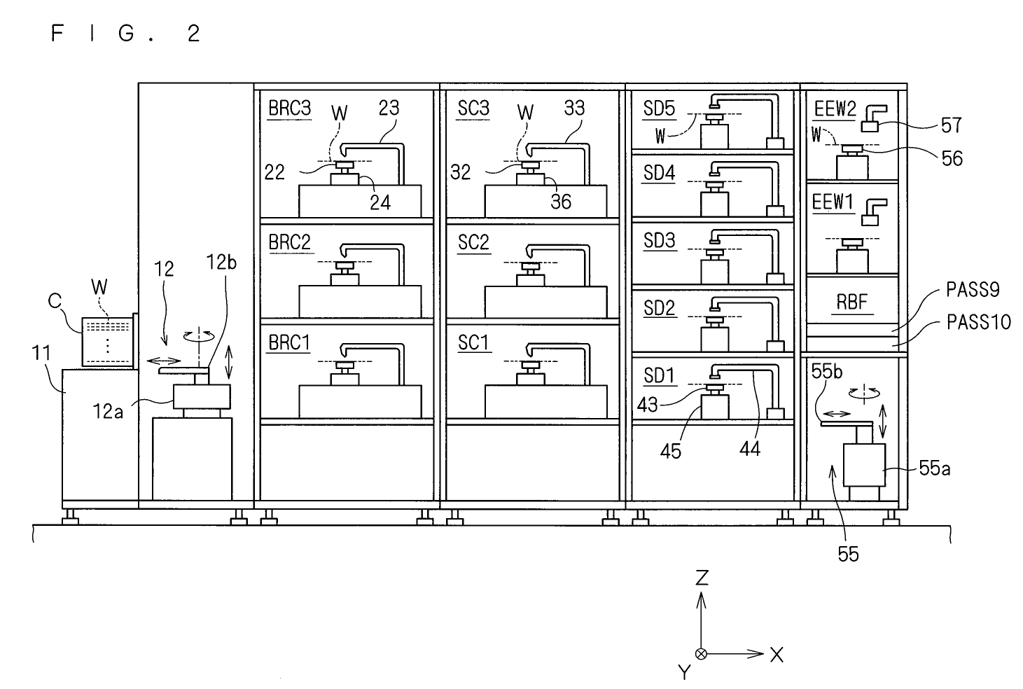

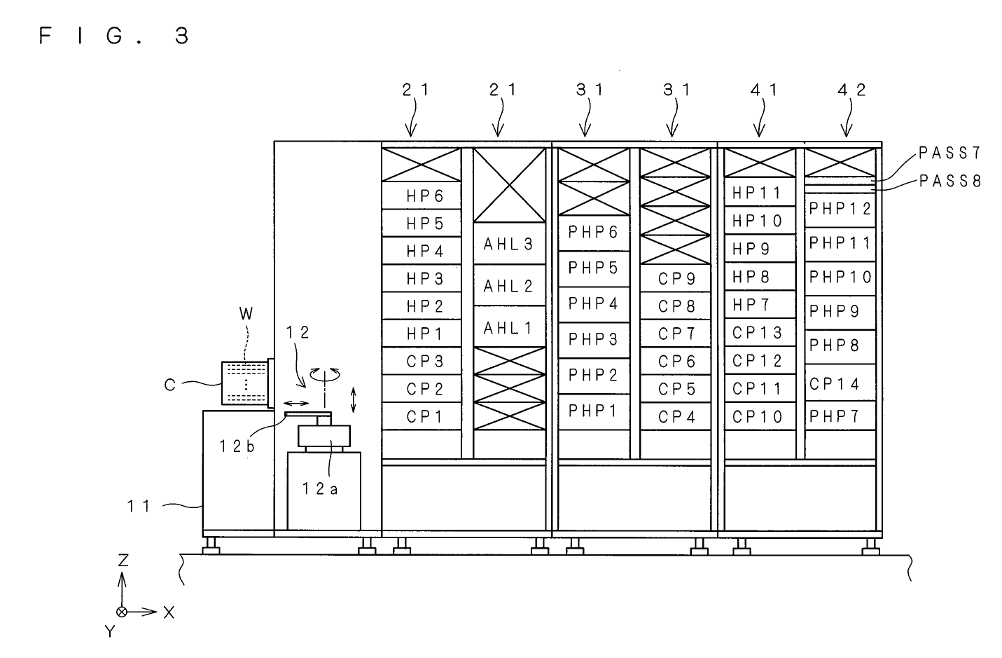

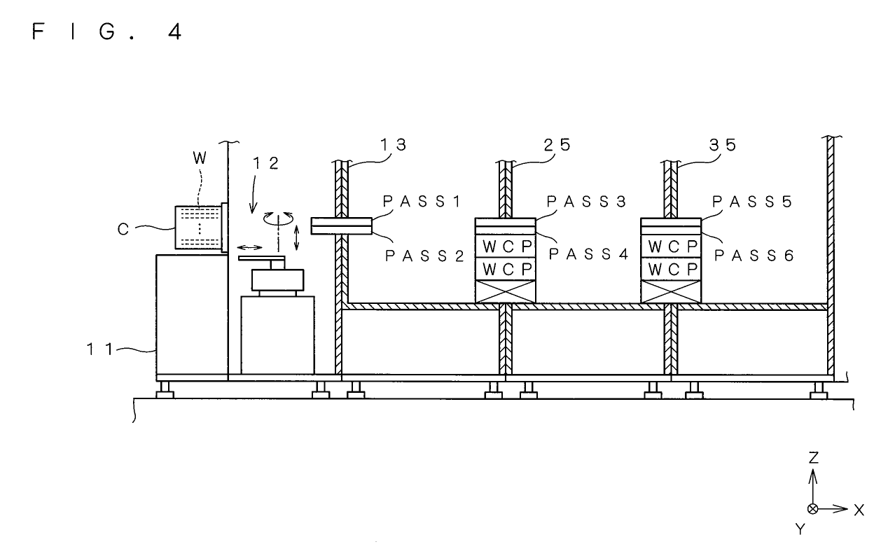

FIG. 1 is a plan view of a substrate processing apparatus RF according to the present invention. FIG. 2 is a front view of a liquid processing part in the substrate processing apparatus RF. FIG. 3 is a front view of a thermal processing part in the substrate processing apparatus RF. FIG. 4 is a view showing a construction around substrate rest parts. An XYZ rectangular coordinate system in which an XY plane is defined as the horizontal plane and a Z axis is defined to extend in the vertical direction is additionally shown in FIGS. 1 through 4 for purposes of clarifying the directional relationship therebetween.

The substrate processing apparatus RF according to the preferred embodiment is an apparatus for forming an anti-reflective film and a photoresist film on substrates such as semiconductor wafers by coating and for performing a development process on substrates subjected to a pattern exposure process. The substrates to be processed by the substrate processing apparatus according to the present invention are not limited to semiconductor wafers, but may include glass substrates for a liquid crystal display device, and the like.

The substrate processing apparatus RF according to the preferred embodiment comprises an indexer block 1, a BARC (Bottom Anti-Reflective Coating) block 2, a resist coating block 3, a development processing block 4, and an interface block 5. In the substrate processing apparatus RF, the five processing blocks 1 to 5 are arranged in side-by-side relation. An exposure unit (or stepper) EXP which is an external apparatus separate from the substrate processing apparatus RF according to the present invention is provided and connected to the interface block 5. The substrate processing apparatus RF according to this preferred embodiment and the exposure unit EXP are connected via LAN lines (not shown) to a host computer 100 and a data collection server 200.

The indexer block 1 is a processing block for transferring unprocessed substrates received from the outside of the substrate processing apparatus RF outwardly to the BARC block 2 and the resist coating block 3, and for transporting processed substrates received from the development processing block 4 to the outside of the substrate processing apparatus RF. The indexer block 1 comprises a table 11 for placing thereon a plurality of (in this preferred embodiment, four) cassettes (or carriers) C in juxtaposition, and a substrate transfer mechanism 12 for taking an unprocessed substrate W out of each of the cassettes C and for storing a processed substrate W into each of the cassettes C. The substrate transfer mechanism 12 includes a movable base 12a movable horizontally (in the Y direction) along the table 11, and a holding arm 12b mounted on the movable base 12a and for holding a substrate W in a horizontal position. The holding arm 12b is capable of moving vertically (in the Z direction) over the movable base 12a, pivoting within a horizontal plane and moving back and forth in the direction of the pivot radius. Thus, the substrate transfer mechanism 12 can cause the holding arm 12b to gain access to each of the cassettes C, thereby taking an unprocessed substrate W out of each cassette C and storing a processed substrate W into each cassette C. The cassettes C may be of the following types: an SMIF (standard mechanical interface) pod, and an OC (open cassette) which exposes stored substrates W to the atmosphere, in addition to a FOUP (front opening unified pod) which stores substrates W in an enclosed or sealed space.

The BARC block 2 is provided in adjacent relation to the indexer block 1. A partition 13 for closing off the communication of atmosphere is provided between the indexer block 1 and the BARC block 2. The partition 13 is provided with a pair of vertically arranged substrate rest parts PASS1 and PASS2 each for placing a substrate W thereon for the transfer of the substrate W between the indexer block 1 and the BARC block 2.

The upper substrate rest part PASS1 is used for the transport of a substrate W from the indexer block 1 to the BARC block 2. The substrate rest part PASS1 includes three support pins. The substrate transfer mechanism 12 of the indexer block 1 places an unprocessed substrate W taken out of one of the cassettes C onto the three support pins of the substrate rest part PASS1. A transport robot TR1 of the BARC block 2 to be described later receives the substrate W placed on the substrate rest part PASS1. The lower substrate rest part PASS2, on the other hand, is used for the transport of a substrate W from the BARC block 2 to the indexer block 1. The substrate rest part PASS2 also includes three support pins. The transport robot TR1 of the BARC block 2 places a processed substrate W onto the three support pins of the substrate rest part PASS2. The substrate transfer mechanism 12 receives the substrate W placed on the substrate rest part PASS2 and stores the substrate W into one of the cassettes C. Pairs of substrate rest parts PASS3 to PASS10 to be described later are similar in construction to the pair of substrate rest parts PASS1 and PASS2.

The substrate rest parts PASS1 and PASS2 extend through the partition 13. Each of the substrate rest parts PASS1 and PASS2 includes an optical sensor (not shown) for detecting the presence or absence of a substrate W thereon. Based on a detection signal from each of the sensors, a judgment is made as to whether or not the substrate transfer mechanism 12 and the transport robot TR1 of the BARC block 2 stand ready to transfer and receive a substrate W to and from the substrate rest parts PASS1 and PASS2.

Next, the BARC block 2 will be described. The BARC block 2 is a processing block for forming an anti-reflective film by coating at the bottom of a photoresist film (i.e., as an undercoating film for the photoresist film) to reduce standing waves or halation occurring during exposure. The BARC block 2 comprises a bottom coating processor BRC for coating the surface of a substrate W with the anti-reflective film, a pair of thermal processing towers 21 for performing a thermal process which accompanies the formation of the anti-reflective film by coating, and the transport robot TR1 for transferring and receiving a substrate W to and from the bottom coating processor BRC and the pair of thermal processing towers 21.

In the BARC block 2, the bottom coating processor BRC and the pair of thermal processing towers 21 are arranged on opposite sides of the transport robot TR1. Specifically, the bottom coating processor BRC is on the front side of the substrate processing apparatus RF, and the pair of thermal processing towers 21 are on the rear side thereof. Additionally, a thermal barrier not shown is provided on the front side of the pair of thermal processing towers 21. Thus, the thermal effect of the pair of thermal processing towers 21 upon the bottom coating processor BRC is avoided by spacing the bottom coating processor BRC apart from the pair of thermal processing towers 21 and by providing the thermal barrier.

As shown in FIG. 2, the bottom coating processor BRC includes three coating processing units BRC1, BRC2 and BRC3 similar in construction to each other and arranged in stacked relation in bottom-to-top order. The three coating processing units BRC1, BRC2 and BRC3 are collectively referred to as the bottom coating processor BRC, unless otherwise identified. Each of the coating processing units BRC1, BRC2 and BRC3 includes a spin chuck 22 for rotating a substrate W in a substantially horizontal plane while holding the substrate W in a substantially horizontal position under suction, a coating nozzle 23 for applying a coating solution for the anti-reflective film onto the substrate W held on the spin chuck 22, a spin motor 24 for rotatably driving the spin chuck 22, a cup (not shown) surrounding the substrate W held on the spin chuck 22, and the like.

As shown in FIG. 3, one of the thermal processing towers 21 which is closer to the indexer block 1 includes six hot plates HP1 to HP6 for heating a substrate W up to a predetermined temperature, and cool plates CP1 to CP3 for cooling a heated substrate W down to a predetermined temperature and maintaining the substrate W at the predetermined temperature. The cool plates CP1 to CP3 and the hot plates HP1 to HP6 are arranged in stacked relation in bottom-to-top order in this thermal processing tower 21. The other of the thermal processing towers 21 which is farther from the indexer block 1 includes three adhesion promotion processing parts AHL1 to AHL3 arranged in stacked relation in bottom-to-top order for thermally processing a substrate W in a vapor atmosphere of HMDS (hexamethyl disilazane) to promote the adhesion of the resist film to the substrate W. The locations indicated by the cross marks (x) in FIG. 3 are occupied by a piping and wiring section or reserved as empty space for future addition of processing units.

Thus, stacking the coating processing units BRC1 to BRC3 and the thermal processing units (the hot plates HP1 to HP6, the cool plates CP1 to CP3, and the adhesion promotion processing parts AHL1 to AHL3 in the BARC block 2) in tiers provides smaller space occupied by the substrate processing apparatus RF to reduce the footprint thereof. The side-by-side arrangement of the pair of thermal processing towers 21 is advantageous in facilitating the maintenance of the thermal processing units and in eliminating the need for extension of ducting and power supply equipment necessary for the thermal processing units to a much higher position.

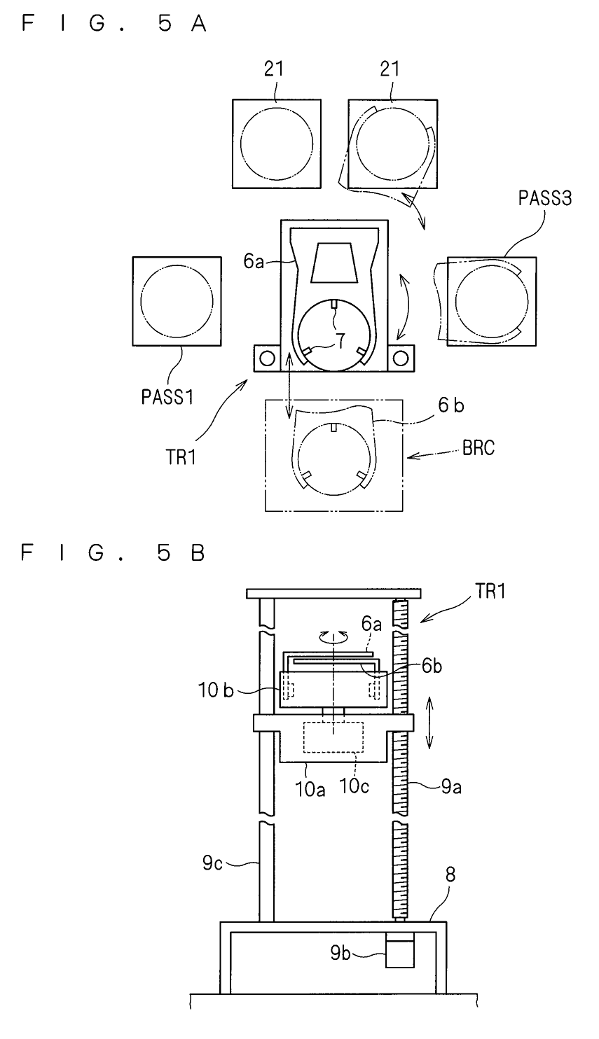

FIGS. 5A and 5B are views for illustrating the transport robot TR1. FIG. 5A is a plan view of the transport robot TR1, and FIG. 5B is a front view of the transport robot TR1. The transport robot TR1 includes a pair of (upper and lower) holding arms 6a and 6b in proximity to each other for holding a substrate W in a substantially horizontal position. Each of the holding arms 6a and 6b includes a distal end portion of a substantially C-shaped plan configuration, and a plurality of pins 7 projecting inwardly from the inside of the substantially C-shaped distal end portion for supporting the peripheral edge of a substrate W from below.

The transport robot TR1 further includes a base 8 fixedly mounted on an apparatus base (or an apparatus frame). A guide shaft 9c is mounted upright on the base 8, and a threaded shaft 9a is rotatably mounted and supported upright on the base 8. A motor 9b for rotatably driving the threaded shaft 9a is fixedly mounted to the base 8. A lift 10a is in threaded engagement with the threaded shaft 9a, and is freely slidable relative to the guide shaft 9c. With such an arrangement, the motor 9b rotatably drives the threaded shaft 9a, whereby the lift 10a is guided by the guide shaft 9c to move up and down in a vertical direction (in the Z direction).

An arm base 10b is mounted on the lift 10a pivotably about a vertical axis. The lift 10a contains a motor 10c for pivotably driving the arm base 10b. The pair of (upper and lower) holding arms 6a and 6b described above are provided on the arm base 10b. Each of the holding arms 6a and 6b is independently movable back and forth in a horizontal direction (in the direction of the pivot radius of the arm base 10b) by a sliding drive mechanism (not shown) mounted to the arm base 10b.

With such an arrangement, the transport robot TR1 is capable of causing each of the pair of holding arms 6a and 6b to independently gain access to the substrate rest parts PASS1 and PASS2, the thermal processing units provided in the thermal processing towers 21, the coating processing units provided in the bottom coating processor BRC, and the substrate rest parts PASS3 and PASS4 to be described later, thereby transferring and receiving substrates W to and from the above-mentioned parts and units, as shown in FIG. 5A.

Next, the resist coating block 3 will be described. The resist coating block 3 is provided so as to be sandwiched between the BARC block 2 and the development processing block 4. A partition 25 for closing off the communication of atmosphere is also provided between the resist coating block 3 and the BARC block 2. The partition 25 is provided with the pair of vertically arranged substrate rest parts PASS3 and PASS4 each for placing a substrate W thereon for the transfer of the substrate W between the BARC block 2 and the resist coating block 3. The substrate rest parts PASS3 and PASS4 are similar in construction to the above-mentioned substrate rest parts PASS1 and PASS2.

The upper substrate rest part PASS3 is used for the transport of a substrate W from the BARC block 2 to the resist coating block 3. Specifically, a transport robot TR2 of the resist coating block 3 receives the substrate W placed on the substrate rest part PASS3 by the transport robot TR1 of the BARC block 2. The lower substrate rest part PASS4, on the other hand, is used for the transport of a substrate W from the resist coating block 3 to the BARC block 2. Specifically, the transport robot TR1 of the BARC block 2 receives the substrate W placed on the substrate rest part PASS4 by the transport robot TR2 of the resist coating block 3.

The substrate rest parts PASS3 and PASS4 extend through the partition 25. Each of the substrate rest parts PASS3 and PASS4 includes an optical sensor (not shown) for detecting the presence or absence of a substrate W thereon. Based on a detection signal from each of the sensors, a judgment is made as to whether or not the transport robots TR1 and TR2 stand ready to transfer and receive a substrate W to and from the substrate rest parts PASS3 and PASS4. A pair of (upper and lower) cool plates WCP of a water-cooled type for roughly cooling a substrate W are provided under the substrate rest parts PASS3 and PASS4, and extend through the partition 25 (FIG. 4).

The resist coating block 3 is a processing block for applying a resist onto a substrate W coated with the anti-reflective film by the BARC block 2 to form a resist film. In this preferred embodiment, a chemically amplified resist is used as the photoresist. The resist coating block 3 comprises a resist coating processor SC for forming the resist film by coating on the anti-reflective film serving as the undercoating film, a pair of thermal processing towers 31 for performing a thermal process which accompanies the resist coating process, and the transport robot TR2 for transferring and receiving a substrate W to and from the resist coating processor SC and the pair of thermal processing towers 31.

In the resist coating block 3, the resist coating processor SC and the pair of thermal processing towers 31 are arranged on opposite sides of the transport robot TR2. Specifically, the resist coating processor SC is on the front side of the substrate processing apparatus RF, and the pair of thermal processing towers 31 are on the rear side thereof. Additionally, a thermal barrier not shown is provided on the front side of the pair of thermal processing towers 31. Thus, the thermal effect of the pair of thermal processing towers 31 upon the resist coating processor SC is avoided by spacing the resist coating processor SC apart from the pair of thermal processing towers 31 and by providing the thermal barrier.

As shown in FIG. 2, the resist coating processor SC includes three coating processing units SC1, SC2 and SC3 similar in construction to each other and arranged in stacked relation in bottom-to-top order. The three coating processing units SC1, SC2 and SC3 are collectively referred to as the resist coating processor SC, unless otherwise identified. Each of the coating processing units SC1, SC2 and SC3 includes a spin chuck 32 for rotating a substrate W in a substantially horizontal plane while holding the substrate W in a substantially horizontal position under suction, a coating nozzle 33 for applying a resist solution onto the substrate W held on the spin chuck 32, a spin motor 36 for rotatably driving the spin chuck 32, a cup (not shown) surrounding the substrate W held on the spin chuck 32, and the like.

As shown in FIG. 3, one of the thermal processing towers 31 which is closer to the indexer block 1 includes six heating parts PHP1 to PHP6 arranged in stacked relation in bottom-to-top order for heating a substrate W up to a predetermined temperature. The other of the thermal processing towers 31 which is farther from the indexer block 1 includes cool plates CP4 to CP9 arranged in stacked relation in bottom-to-top order for cooling a heated substrate W down to a predetermined temperature and maintaining the substrate W at the predetermined temperature.

Each of the heating parts PHP1 to PHP6 is a thermal processing unit including, in addition to an ordinary hot plate for heating a substrate W placed thereon, a temporary substrate rest part for placing a substrate W in an upper position spaced apart from the hot plate, and a local transport mechanism 34 (see FIG. 1) for transporting a substrate W between the hot plate and the temporary substrate rest part. The local transport mechanism 34 is capable of moving vertically and moving back and forth, and includes a mechanism for cooling down a substrate W being transported by circulating cooling water therein.

The local transport mechanism 34 is provided on the opposite side of the above-mentioned hot plate and the temporary substrate rest part from the transport robot TR2, that is, on the rear side of the substrate processing apparatus RF. The temporary substrate rest part has both an open side facing the transport robot TR2 and an open side facing the local transport mechanism 34. The hot plate, on the other hand, has only an open side facing the local transport mechanism 34, and a closed side facing the transport robot TR2. Thus, both of the transport robot TR2 and the local transport mechanism 34 can gain access to the temporary substrate rest part, but only the local transport mechanism 34 can gain access to the hot plate.

A substrate W is transported into each of the heating parts PHP1 to PHP6 having the above-mentioned construction in a manner to be described below. First, the transport robot TR2 places a substrate W onto the temporary substrate rest part. Subsequently, the local transport mechanism 34 receives the substrate W from the temporary substrate rest part to transport the substrate W to the hot plate. The hot plate performs a heating process on the substrate W. The local transport mechanism 34 takes out the substrate W subjected to the heating process by the hot plate, and transports the substrate W to the temporary substrate rest part. During the transport, the substrate W is cooled down by the cooling function of the local transport mechanism 34. Thereafter, the transport robot TR2 takes out the substrate W subjected to the heating process and transported to the temporary substrate rest part.

As discussed above, the transport robot TR2 transfers and receives the substrate W to and from only the temporary substrate rest part held at room temperature in each of the heating parts PHP1 to PHP6, but does not transfer and receive the substrate W directly to and from the hot plate. This avoids the temperature rise of the transport robot TR2. The hot plate having only the open side facing the local transport mechanism 34 prevents the heat atmosphere leaking out of the hot plate from affecting the transport robot TR2 and the resist coating processor SC. The transport robot TR2 transfers and receives a substrate W directly to and from the cool plates CP4 to CP9.

The transport robot TR2 is precisely identical in construction with the transport robot TR1. Thus, the transport robot TR2 is capable of causing each of a pair of holding arms thereof to independently gain access to the substrate rest parts PASS3 and PASS4, the thermal processing units provided in the thermal processing towers 31, the coating processing units provided in the resist coating processor SC, and the substrate rest parts PASS5 and PASS6 to be described later, thereby transferring and receiving substrates W to and from the above-mentioned parts and units.

Next, the development processing block 4 will be described. The development processing block 4 is provided so as to be sandwiched between the resist coating block 3 and the interface block 5. A partition 35 for closing off the communication of atmosphere is also provided between the resist coating block 3 and the development processing block 4. The partition 35 is provided with the pair of vertically arranged substrate rest parts PASS5 and PASS6 each for placing a substrate W thereon for the transfer of the substrate W between the resist coating block 3 and the development processing block 4. The substrate rest parts PASS5 and PASS6 are similar in construction to the above-mentioned substrate rest parts PASS1 and PASS2.

The upper substrate rest part PASS5 is used for the transport of a substrate W from the resist coating block 3 to the development processing block 4. Specifically, a transport robot TR3 of the development processing block 4 receives the substrate W placed on the substrate rest part PASS5 by the transport robot TR2 of the resist coating block 3. The lower substrate rest part PASS6, on the other hand, is used for the transport of a substrate W from the development processing block 4 to the resist coating block 3. Specifically, the transport robot TR2 of the resist coating block 3 receives the substrate W placed on the substrate rest part PASS6 by the transport robot TR3 of the development processing block 4.

The substrate rest parts PASS5 and PASS6 extend through the partition 35. Each of the substrate rest parts PASS5 and PASS6 includes an optical sensor (not shown) for detecting the presence or absence of a substrate W thereon. Based on a detection signal from each of the sensors, a judgment is made as to whether or not the transport robots TR2 and TR3 stand ready to transfer and receive a substrate W to and from the substrate rest parts PASS5 and PASS6. A pair of (upper and lower) cool plates WCP of a water-cooled type for roughly cooling a substrate W are provided under the substrate rest parts PASS5 and PASS6, and extend through the partition 35 (FIG. 4).

The development processing block 4 is a processing block for performing a development process on an exposed substrate W. The development processing block 4 comprises a development processor SD for applying a developing solution onto a substrate W exposed in a pattern to perform the development process, a pair of thermal processing towers 41 and 42 for performing a thermal process which accompanies the development process, and the transport robot TR3 for transferring and receiving a substrate W to and from the development processor SD and the pair of thermal processing towers 41 and 42. The transport robot TR3 is precisely identical in construction to the above-mentioned transport robots TR1 and TR2.

As shown in FIG. 2, the development processor SD includes five development processing units SD1, SD2, SD3, SD4 and SD5 similar in construction to each other and arranged in stacked relation in bottom-to-top order. The five development processing units SD1 to SD5 are collectively referred to as the development processor SD, unless otherwise identified. Each of the development processing units SD1 to SD5 includes a spin chuck 43 for rotating a substrate W in a substantially horizontal plane while holding the substrate W in a substantially horizontal position under suction, a nozzle 44 for applying the developing solution onto the substrate W held on the spin chuck 43, a spin motor 45 for rotatably driving the spin chuck 43, a cup (not shown) surrounding the substrate W held on the spin chuck 43, and the like.

As shown in FIG. 3, the thermal processing tower 41 which is closer to the indexer block 1 includes five hot plates HP7 to HP11 for heating a substrate W up to a predetermined temperature, and cool plates CP10 to CP13 for cooling a heated substrate W down to a predetermined temperature and maintaining the substrate W at the predetermined temperature. The cool plates CP10 to CP13 and the hot plates HP7 to HP11 are arranged in stacked relation in bottom-to-top order in this thermal processing tower 41. The thermal processing tower 42 which is farther from the indexer block 1, on the other hand, includes six heating parts PHP7 to PHP12 and a cool plate CP14 which are arranged in stacked relation. Like the above-mentioned heating parts PHP1 to PHP6, each of the heating parts PHP7 to PHP12 is a thermal processing unit including a temporary substrate rest part and a local transport mechanism. However, the temporary substrate rest part of each of the heating parts PHP7 to PHP12 and the cool plate CP14 have an open side facing a transport robot TR4 of the interface block 5, and a closed side facing the transport robot TR3 of the development processing block 4. In other words, the transport robot TR4 of the interface block 5 can gain access to the heating parts PHP7 to PHP12 and the cool plate CP14, but the transport robot TR3 of the development processing block 4 cannot gain access thereto. The transport robot TR3 of the development processing block 4 gains access to the thermal processing units incorporated in the thermal processing tower 41.

The pair of vertically arranged substrate rest parts PASS7 and PASS8 in proximity to each other for the transfer of a substrate W between the development processing block 4 and the interface block 5 adjacent thereto are incorporated in the top tier of the thermal processing tower 42. The upper substrate rest part PASS7 is used for the transport of a substrate W from the development processing block 4 to the interface block 5. Specifically, the transport robot TR4 of the interface block 5 receives the substrate W placed on the substrate rest part PASS7 by the transport robot TR3 of the development processing block 4. The lower substrate rest part PASS8, on the other hand, is used for the transport of a substrate W from the interface block 5 to the development processing block 4. Specifically, the transport robot TR3 of the development processing block 4 receives the substrate W placed on the substrate rest part PASS8 by the transport robot TR4 of the interface block 5. Each of the substrate rest parts PASS7 and PASS8 includes both an open side facing the transport robot TR3 of the development processing block 4 and an open side facing the transport robot TR4 of the interface block 5.

Next, the interface block 5 will be described. The interface block 5 is a block provided adjacent to the development processing block 4. The interface block 5 receives a substrate W with the resist film formed thereon by the resist coating process from the resist coating block 3 to transfer the substrate W to the exposure unit EXP which is an external apparatus separate from the substrate processing apparatus RF according to the present invention. Also, the interface block 5 receives an exposed substrate W from the exposure unit EXP to transfer the exposed substrate W to the development processing block 4. The interface block 5 in this preferred embodiment comprises a transport mechanism 55 for transferring and receiving a substrate W to and from the exposure unit EXP, a pair of edge exposure units EEW1 and EEW2 for exposing the periphery of a substrate W formed with the resist film, and the transport robot TR4 for transferring and receiving a substrate W to and from the heating parts PHP7 to PHP12 and cool plate CP14 provided in the development processing block 4 and the edge exposure units EEW1 and EEW2.

As shown in FIG. 2, each of the edge exposure units EEW1 and EEW2 (collectively referred to as an edge exposure part EEW, unless otherwise identified) includes a spin chuck 56 for rotating a substrate W in a substantially horizontal plane while holding the substrate W in a substantially horizontal position under suction, a light irradiator 57 for exposing the periphery of the substrate W held on the spin chuck 56 to light, and the like. The pair of edge exposure units EEW1 and EEW2 are arranged in vertically stacked relation in the center of the interface block 5. The transport robot TR4 provided adjacent to the edge exposure part EEW and the thermal processing tower 42 of the development processing block 4 is similar in construction to the above-mentioned transport robots TR1 to TR3.

As illustrated also in FIG. 2, a return buffer RBF for the return of substrates W is provided under the pair of edge exposure units EEW1 and EEW2, and the pair of vertically arranged substrate rest parts PASS9 and PASS10 are provided under the return buffer RBF. The return buffer RBF is provided to temporarily store a substrate W subjected to a post-exposure heating process in the heating parts PHP7 to PHP12 of the development processing block 4 if the development processing block 4 is unable to perform the development process on the substrate W because of some sort of malfunction and the like. The return buffer RBF includes a cabinet capable of storing a plurality of substrates W in tiers. The upper substrate rest part PASS9 is used for the transfer of a substrate W from the transport robot TR4 to the transport mechanism 55. The lower substrate rest part PASS10 is used for the transfer of a substrate W from the transport mechanism 55 to the transport robot TR4. The transport robot TR4 gains access to the return buffer RBF.

The transport mechanism 55 includes a movable base 55a movable horizontally in the Y direction, and a holding arm 55b mounted on the movable base 55a and for holding a substrate W, as illustrated in FIG. 2. The holding arm 55b is capable of moving vertically, pivoting and moving back and forth in the direction of the pivot radius relative to the movable base 55a. With such an arrangement, the transport mechanism 55 transfers and receives a substrate W to and from the exposure unit EXP, transfers and receives a substrate W to and from the substrate rest parts PASS9 and PASS10, and stores and takes a substrate W into and out of a send buffer SBF for the sending of substrates W. The send buffer SBF is provided to temporarily store a substrate W prior to the exposure process if the exposure unit EXP is unable to accept the substrate W, and includes a cabinet capable of storing a plurality of substrates W in tiers.

A downflow of clean air is always supplied into the indexer block 1, the BARC block 2, the resist coating block 3, the development processing block 4, and the interface block 5 described above to thereby avoid the adverse effects of raised particles and gas flows upon the processes in the respective blocks 1 to 5. Additionally, a slightly positive pressure relative to the external environment of the substrate processing apparatus RF is maintained in each of the blocks 1 to 5 to prevent the entry of particles and contaminants from the external environment into the blocks 1 to 5.

The indexer block 1, the BARC block 2, the resist coating block 3, the development processing block 4 and the interface block 5 as described above are units into which the substrate processing apparatus RF of this preferred embodiment is divided in mechanical terms. The blocks 1 to 5 are assembled to individual block frames, respectively, which are in turn connected together to construct the substrate processing apparatus RF.

On the other hand, this preferred embodiment employs another type of units, that is, transport control units regarding the transport of substrates, aside from the blocks which are units based on the above-mentioned mechanical division. The transport control units regarding the transport of substrates are referred to herein as “cells.” Each of the cells comprises a transport robot responsible for the transport of substrates, and a transport destination part to which the transport robot transports a substrate. Each of the substrate rest parts described above functions as an entrance substrate rest part for the receipt of a substrate W into a cell or as an exit substrate rest part for the transfer of a substrate W out of a cell. The transfer of substrates W between the cells is carried out through the substrate rest parts. The transport robots constituting the cells include the substrate transfer mechanism 12 of the indexer block 1 and the transport mechanism 55 of the interface block 5.

The substrate processing apparatus RF in this preferred embodiment comprises six cells: an indexer cell, a BARC cell, a resist coating cell, a development processing cell, a post-exposure bake cell, and an interface cell. The indexer cell includes the table 11 and the substrate transfer mechanism 12, and is consequently similar in construction to the indexer block 1 which is one of the units based on the mechanical division. The BARC cell includes the bottom coating processor BRC, the pair of thermal processing towers 21 and the transport robot TR1. The BARC cell is also consequently similar in construction to the BARC block 2 which is one of the units based on the mechanical division. The resist coating cell includes the resist coating processor SC, the pair of thermal processing towers 31, and the transport robot TR2. The resist coating cell is also consequently similar in construction to the resist coating block 3 which is one of the units based on the mechanical division.

The development processing cell includes the development processor SD, the thermal processing tower 41, and the transport robot TR3. Because the transport robot TR3 cannot gain access to the heating parts PHP7 to PHP12 and the cool plate CP14 of the thermal processing tower 42 as discussed above, the development processing cell does not include the thermal processing tower 42. In this respect, the development processing cell differs from the development processing block 4 which is one of the units based on the mechanical division.

The post-exposure bake cell includes the thermal processing tower 42 positioned in the development processing block 4, the edge exposure part EEW positioned in the interface block 5, and the transport robot TR4 positioned in the interface block 5. That is, the post-exposure bake cell extends over the development processing block 4 and the interface block 5 which are units based on the mechanical division. In this manner, constituting one cell including the heating parts PHP7 to PHP12 for performing the post-exposure heating process and the transport robot TR4 allows the rapid transport of exposed substrates W into the heating parts PHP7 to PHP12 for the execution of the thermal process. Such an arrangement is preferred for the use of a chemically amplified resist which is required to be subjected to a heating process as soon as possible after the exposure of a substrate W in a pattern.

The substrate rest parts PASS7 and PASS8 included in the thermal processing tower 42 are provided for the transfer of a substrate W between the transport robot TR3 of the development processing cell and the transport robot TR4 of the post-exposure bake cell.

The interface cell includes the transport mechanism 55 for transferring and receiving a substrate W to and from the exposure unit EXP which is an external apparatus. The interface cell differs from the interface block 5 which is one of the units based on the mechanical division in that the interface cell does not include the transport robot TR4 and the edge exposure part EEW. The substrate rest parts PASS9 and PASS10 under the edge exposure part EEW are provided for the transfer of a substrate W between the transport robot TR4 of the post-exposure bake cell and the transport mechanism 55 of the interface cell.

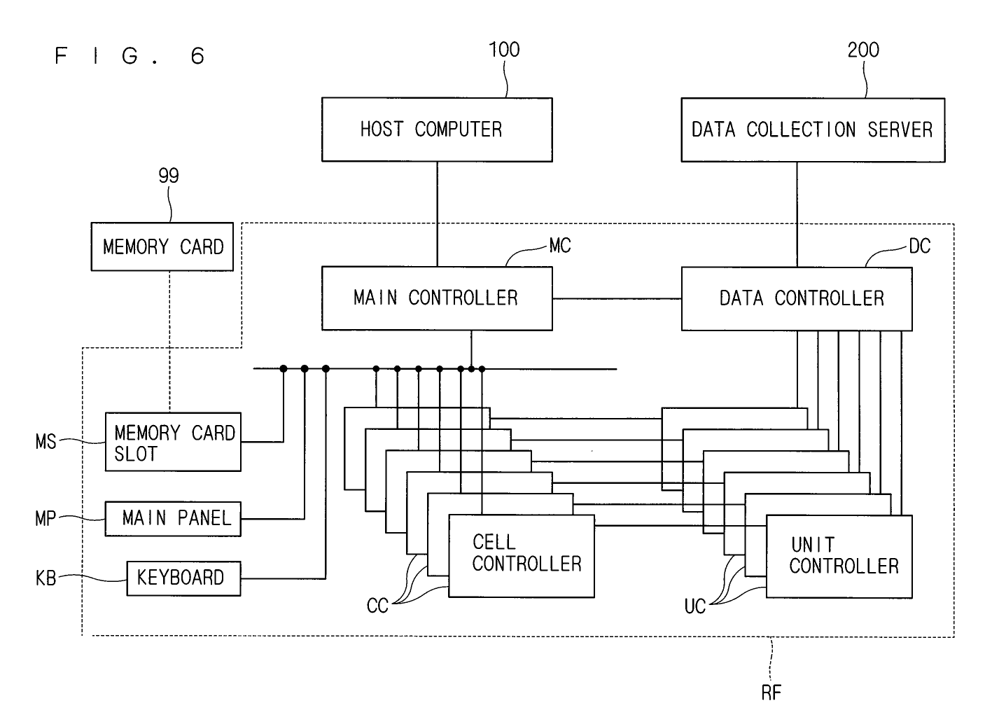

A control mechanism for the substrate processing apparatus RF of this preferred embodiment will be described. FIG. 6 is a block diagram schematically showing the control mechanism. As shown in FIG. 6, the substrate processing apparatus RF of this preferred embodiment has a three-level control hierarchy composed of a main controller MC, cell controllers CC and unit controllers UC, and further includes a data controller DC. The main controller MC, the cell controllers CC, the unit controllers UC and the data controller DC are similar in hardware construction to typical computers. Specifically, each of the controllers comprises a CPU for performing various computation processes, a ROM or read-only memory for storing a basic program therein, a RAM or readable/writable memory for storing various pieces of information therein, a magnetic disk for storing control applications and data therein, and the like.

The single main controller MC at the first level is provided for the entire substrate processing apparatus RF, and is principally responsible for the management of the entire substrate processing apparatus RF. The main controller MC ranking as a higher level controller than the cell controllers CC to be described later provides instructions to the cell controllers CC and receives information from the cell controllers CC. A keyboard KB functioning as an input device, and a main panel MP functioning as a display are connected to the main controller MC. The main controller MC accepts various commands and parameters inputted from the keyboard KB, and displays various pieces of information on the main panel MP. The main panel MP may be in the form of a touch panel so that a user performs an input process into the main controller MC from the main panel MP.

A memory device is connectable to the main controller MC. The memory device according to the preferred embodiment is a memory card 99. Inserting into a memory card slot MS the memory card 99 on which a program including descriptions about the processes (to be described later) to be executed by the control mechanism for the substrate processing apparatus RF is recorded enables the main controller MC to read the program, thereby installing the program on the substrate processing apparatus RF. The CPU in each of the controllers of the substrate processing apparatus RF executes the program, whereby the controllers perform the processes to be described later. The above-mentioned program may be downloaded, for example, from the host computer 100 by way of a network and then installed on the substrate processing apparatus RF. Other recording media such as a CD-ROM, a DVD and the like may be used in place of the memory card 99. In this case, the above-mentioned program is recorded on the CD-ROM, the DVD and the like, and a purpose-built optical disk unit (e.g., a CD-ROM drive for the CD-ROM, and a DVD drive for the DVD) connected to the main controller MC reads the program.

The control mechanisms at the second level include a spin controller, a bake controller, an indexer controller, an interface controller, an edge exposure controller, and the like (all of which are not shown) in addition to the cell controllers CC. The cell controllers CC are individually provided in corresponding relation to the six cells (the indexer cell, the BARC cell, the resist coating cell, the development processing cell, the post-exposure bake cell, and the interface cell). The cell controllers CC are controllers intermediate between the main controller MC and the unit controllers UC. Each of the cell controllers CC is principally responsible for the control of the transport of substrates in a corresponding cell. Specifically, the cell controllers CC for the respective cells send and receive information in such a manner that a first cell controller CC for a first cell sends information indicating that a substrate W is placed on a predetermined substrate rest part to a second cell controller CC for a second cell adjacent to the first cell, and the second cell controller CC for the second cell having received the substrate W sends information indicating that the substrate W is received from the predetermined substrate rest part back to the first cell controller CC. Such sending and receipt of information are carried out through the main controller MC. When receiving the information indicating that a substrate W is transported into a corresponding cell, each of the cell controllers CC controls a corresponding transport robot to circulatingly transport the substrate W in the corresponding cell in accordance with a predetermined procedure.

The spin controller and the bake controller, on the other hand, are principally responsible for the management of the units in a corresponding cell. As an example, a single spin controller is provided for each of the bottom coating processor BRC, the resist coating processor SC, and the development processor SD. The spin controller corresponding to the resist coating processor SC is responsible for the management of the three coating processing units SC1, SC2 and SC3. Similarly, the spin controller corresponding to the development processor SD is responsible for the management of the five development processing units SD1, SD2, SD3, SD4 and SD5. Specifically, the spin controller, the bake controller and the like manage operating parts for the processing units through the unit controllers UC to be described later.

The unit controllers UC at the third level are lower level controllers including, for example, motor control equipment, temperature control equipment, robot control equipment and the like and for directly controlling the processing units. Examples of the unit controllers UC include a spin servo controller and a heater controller. The spin servo controller directly controls the rotation of a substrate in a corresponding spin unit (corresponding to each of the coating processing units and the development processing units) in accordance with an instruction given from a corresponding spin controller. Specifically, the spin servo controller controls, for example, a spin motor for a spin unit to adjust the number of rotations of a substrate W. The heater controller directly controls a corresponding thermal processing unit (corresponding to each of the hot plates, the cool plates, the heating parts, and the like) in accordance with an instruction given from a corresponding bake controller. Specifically, the heater controller controls, for example, a heater incorporated in a hot plate to adjust a plate temperature and the like. The unit controllers UC also report results of detection from various sensors (a temperature sensor, an RPM sensor, an ammeter, a pressure sensor and the like) for detecting operating information about the operating parts for the processing units to the cell controllers CC, the spin controllers, the bake controllers and the like and to the data controller DC to be described below.

The plurality of unit controllers UC are also connected to the data controller DC. The data controller (or monitoring controller) DC analyzes the operating states of the operating parts for the processing units which are transmitted from the unit controllers UC to obtain operating state transition information. If the operating state transition information is abnormal, the data controller DC issues a warning signal to the main controller MC. Such processing of the data controller DC will be described in detail later. The data controller DC is also connected to the data collection server 200 external to the substrate processing apparatus RF, and sends the operating states of the operating parts for the processing units which are transmitted from the unit controllers UC to the data collection server 200.

The host computer 100 connected via the LAN lines to the substrate processing apparatus RF ranks as a higher level control mechanism than the three-level control hierarchy provided in the substrate processing apparatus RF (see FIG. 1). The host computer 100 comprises a CPU for performing various computation processes, a ROM or read-only memory for storing a basic program therein, a RAM or readable/writable memory for storing various pieces of information therein, a magnetic disk for storing control applications and data therein, and the like. The host computer 100 is similar in construction to a typical computer. Typically, a plurality of substrate processing apparatuses RF according to this preferred embodiment are connected to the host computer 100. The host computer 100 provides a recipe containing descriptions about a processing procedure and processing conditions to each of the substrate processing apparatuses RF connected thereto. The recipe provided from the host computer 100 is stored in a storage part (e.g., a memory) of the main controller MC of each of the substrate processing apparatuses RF.

The data collection server 200 is also connected via the LAN lines to the substrate processing apparatus RF. The data collection server 200 has the function of collecting and accumulating pieces of information transmitted from the data controller DC and the function of displaying the pieces of information.

The exposure unit EXP is provided with a separate controller independent of the above-mentioned control mechanism for the substrate processing apparatus RF. In other words, the exposure unit EXP does not operate under the control of the main controller MC of the substrate processing apparatus RF, but controls its own operation alone. Such an exposure unit EXP also controls its own operation in accordance with a recipe received from the host computer 100, and the substrate processing apparatus RF performs processes synchronized with the exposure process in the exposure unit EXP.

Next, the operation of the substrate processing apparatus RF of this preferred embodiment will be described. First, brief description will be given on a general procedure for the typical circulating transport of substrates W in the substrate processing apparatus RF. The processing procedure to be described below is in accordance with the descriptions of the recipe received from the host computer 100.

First, unprocessed substrates W stored in a cassette C are transported from the outside of the substrate processing apparatus RF into the indexer block 1 by an AGV (automatic guided vehicle) and the like. Subsequently, the unprocessed substrates W are transferred outwardly from the indexer block 1. Specifically, the substrate transfer mechanism 12 in the indexer cell (or the indexer block 1) takes an unprocessed substrate W out of a predetermined cassette C, and places the unprocessed substrate W onto the substrate rest part PASS1. After the unprocessed substrate W is placed on the substrate rest part PASS1, the transport robot TR1 of the BARC cell uses one of the holding arms 6a and 6b to receive the unprocessed substrate W. The transport robot TR1 transports the received unprocessed substrate W to one of the coating processing units BRC1 to BRC3. In the coating processing units BRC1 to BRC3, the substrate W is spin-coated with the coating solution for the anti-reflective film.

After the completion of the coating process, the transport robot TR1 transports the substrate W to one of the hot plates HP1 to HP6. Heating the substrate W in the hot plate dries the coating solution to form the anti-reflective film serving as the undercoat on the substrate W. Thereafter, the transport robot TR1 takes the substrate W from the hot plate, and transports the substrate W to one of the cool plates CP1 to CP3, which in turn cools down the substrate W. In this step, one of the cool plates WCP may be used to cool down the substrate W. The transport robot TR1 places the cooled substrate W onto the substrate rest part PASS3.

Alternatively, the transport robot TR1 may be adapted to transport the unprocessed substrate W placed on the substrate rest part PASS1 to one of the adhesion promotion processing parts AHL1 to AHL3. In the adhesion promotion processing parts AHL1 to AHL3, the substrate W is thermally processed in a vapor atmosphere of HMDS, whereby the adhesion of the resist film to the substrate W is promoted. The transport robot TR1 takes out the substrate W subjected to the adhesion promotion process, and transports the substrate W to one of the cool plates CP1 to CP3, which in turn cools down the substrate W. Because no anti-reflective film is to be formed on the substrate W subjected to the adhesion promotion process, the cooled substrate W is directly placed onto the substrate rest part PASS3 by the transport robot TR1.

A dehydration process may be performed prior to the application of the coating solution for the anti-reflective film. In this case, the transport robot TR1 transports the unprocessed substrate W placed on the substrate rest part PASS1 first to one of the adhesion promotion processing parts AHL1 to AHL3. In the adhesion promotion processing parts AHL1 to AHL3, a heating process (dehydration bake) merely for dehydration is performed on the substrate W without supplying the vapor atmosphere of HMDS. The transport robot TR1 takes out the substrate W subjected to the heating process for dehydration, and transports the substrate W to one of the cool plates CP1 to CP3, which in turn cools down the substrate W. The transport robot TR1 transports the cooled substrate W to one of the coating processing units BRC1 to BRC3. In the coating processing units BRC1 to BRC3, the substrate W is spin-coated with the coating solution for the anti-reflective film. Thereafter, the transport robot TR1 transports the substrate W to one of the hot plates HP1 to HP6. Heating the substrate W in the hot plate forms the anti-reflective film serving as the undercoat on the substrate W. Thereafter, the transport robot TR1 takes the substrate W from the hot plate, and transports the substrate W to one of the cool plates CP1 to CP3, which in turn cools down the substrate W. Then, the transport robot TR1 places the cooled substrate W onto the substrate rest part PASS3.

After the substrate W is placed on the substrate rest part PASS3, the transport robot TR2 in the resist coating cell receives the substrate W, and transports the substrate W to one of the coating processing units SC1 to SC3. In the coating processing units SC1 to SC3, the substrate W is spin-coated with the resist. Because the resist coating process requires precise substrate temperature control, the substrate W may be transported to one of the cool plates CP4 to CP9 immediately before being transported to the coating processing units SC1 to SC3.

After the completion of the resist coating process, the transport robot TR2 transports the substrate W to one of the heating parts PHP1 to PHP6. In the heating parts PHP1 to PHP6, heating the substrate W removes a solvent component from the resist to form a resist film on the substrate W. Thereafter, the transport robot TR2 takes the substrate W from the one of the heating parts PHP1 to PHP6, and transports the substrate W to one of the cool plates CP4 to CP9, which in turn cools down the substrate W. Then, the transport robot TR2 places the cooled substrate W onto the substrate rest part PASS5.

After the substrate W with the resist film formed thereon by the resist coating process is placed on the substrate rest part PASS5, the transport robot TR3 in the development processing cell receives the substrate W, and places the substrate W onto the substrate rest part PASS7 without any processing of the substrate W. Then, the transport robot TR4 in the post-exposure bake cell receives the substrate W placed on the substrate rest part PASS7, and transports the substrate W to one of the edge exposure units EEW1 and EEW2. In the edge exposure units EEW1 and EEW2, a peripheral edge portion of the substrate W is exposed to light. The transport robot TR4 places the substrate W subjected to the edge exposure process onto the substrate rest part PASS9. The transport mechanism 55 in the interface cell receives the substrate W placed on the substrate rest part PASS9, and transports the substrate W into the exposure unit EXP. The substrate W transported into the exposure unit EXP is subjected to the pattern exposure process. Because the chemically amplified resist is used in this preferred embodiment, an acid is formed by a photochemical reaction in the exposed portion of the resist film formed on the substrate W. The substrate W subjected to the edge exposure process may be transported into the cool plate CP14 by the transport robot TR4 and subjected to a cooling process therein before being transported to the exposure unit EXP.

The exposed substrate W subjected to the pattern exposure process is transported from the exposure unit EXP back to the interface cell again. The transport mechanism 55 places the exposed substrate W onto the substrate rest part PASS10. After the exposed substrate W is placed on the substrate rest part PASS10, the transport robot TR4 in the post-exposure bake cell receives the substrate W, and transports the substrate W to one of the heating parts PHP7 to PHP12. In the heating parts PHP7 to PHP12, the heating process (post-exposure bake) is performed which causes reactions such as crosslinking, polymerization and the like of the resist resin to proceed by using a product formed by the photochemical reaction during the exposure process as an acid catalyst, thereby locally changing the solubility of only the exposed portion of the resist resin in the developing solution. The local transport mechanism (the transport mechanism in the one of the heating parts PHP7 to PHP12; see FIG. 1) having a cooling mechanism transports the substrate W subjected to the post-exposure bake process thereby to cool the substrate W, whereby the above-mentioned chemical reaction stops. Subsequently, the transport robot TR4 takes the substrate W from the one of the heating parts PHP7 to PHP12, and places the substrate W onto the substrate rest part PASS8.

After the substrate W is placed on the substrate rest part PASS8, the transport robot TR3 in the development processing cell receives the substrate W, and transports the substrate W to one of the cool plates CP10 to CP13. In the cool plates CP10 to CP13, the substrate W subjected to the post-exposure bake process is further cooled down and precisely controlled at a predetermined temperature. Thereafter, the transport robot TR3 takes the substrate W from the one of the cool plates CP10 to CP13, and transports the substrate W to one of the development processing units SD1 to SD5. In the development processing units SD1 to SD5, the developing solution is applied onto the substrate W to cause the development process to proceed. After the completion of the development process, the transport robot TR3 transports the substrate W to one of the hot plates HP7 to HP11, and then transports the substrate W to one of the cool plates CP10 to CP13.

Thereafter, the transport robot TR3 places the substrate W onto the substrate rest part PASS6. The transport robot TR2 in the resist coating cell transfers the substrate W from the substrate rest part PASS6 onto the substrate rest part PASS4 without any processing of the substrate W. Next, the transport robot TR1 in the BARC cell transfers the substrate W from the substrate rest part PASS4 onto the substrate rest part PASS2 without any processing of the substrate W, whereby the substrate W is stored in the indexer block 1. Then, the substrate transfer mechanism 12 in the indexer cell stores the processed substrate W held on the substrate rest part PASS2 into a predetermined cassette C. Thereafter, the cassette C in which a predetermined number of processed substrates W are stored is transported to the outside of the substrate processing apparatus RF. Thus, a series of photolithography processes are completed.

The procedure as mentioned above is carried out smoothly by the main controller MC managing the operations of the operating parts for the processing units and the transport robots in the substrate processing apparatus RF through the cell controllers CC, the spin controllers, the bake controllers and the like and through the unit controllers UC in accordance with the descriptions of the recipe received from the host computer 100. The term “operating parts” used herein is a generic term for drivers, mechanical parts and the like for performing operations for the above-mentioned series of photolithography processes. Specific examples of the operating parts include the spin motor 36 in the resist coating processor SC, a resist ejection pump in the resist coating processor SC, heaters in the heating parts PHP7 to PHP12, and the like. Each of the processing units may include a plurality of operating parts.

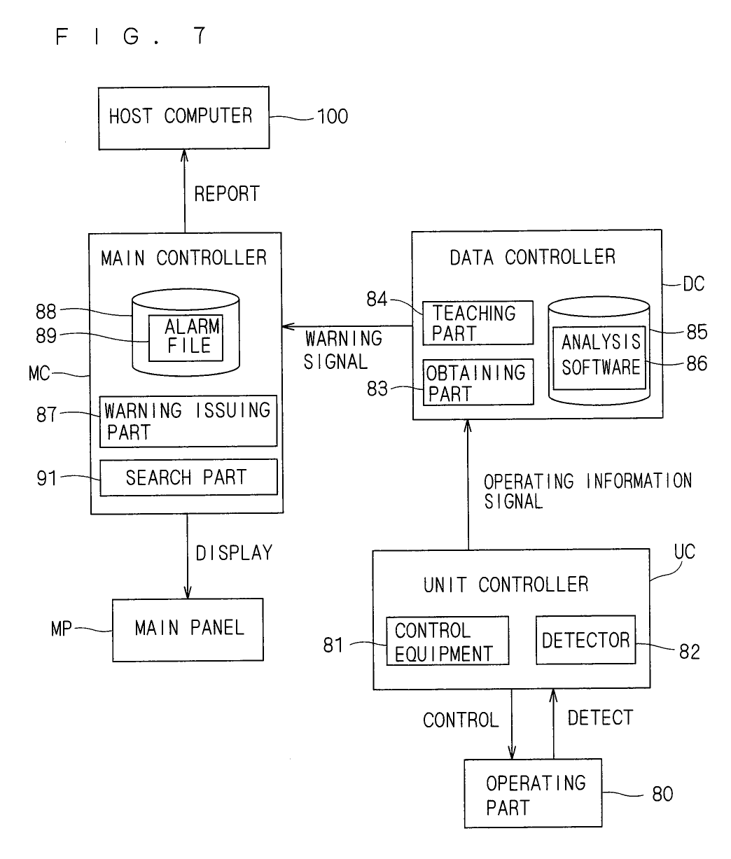

There are cases where an operating anomaly including an irregularity developing into trouble and failure occurs in each of the operating parts. The substrate processing apparatus RF according to the preferred embodiment manages information about such an operating anomaly in a manner to be described below. FIG. 7 shows the details of the management of information about an operating anomaly in each of the operating parts.

As mentioned above, the main controller MC manages the operation of an operating part 80 in the substrate processing apparatus RF through a corresponding cell controller CC, a corresponding spin controller, a corresponding bake controller and the like and through a corresponding unit controller UC. In a more straightforward manner, control equipment 81 (which is a generic term for motor control equipment, temperature control equipment, robot control equipment and the like) in the unit controller UC controls the operating part 80. Operating information about the operating part 80 is detected by a detector 82 (which is a generic term for various sensors such as a temperature sensor, an RPM sensor, an ammeter, a pressure sensor and the like). The operating information about the operating part 80 is a parameter indicating the operating state of the operating part 80. Specifically, the operating information includes, for example, the RPM of the spin motor 36, a flow rate at which the resist is ejected from the coating nozzle 33, the plate temperatures of the heating parts PHP7 to PHP12, and the like.

If the operating state of the operating part 80 is outside a previously set predetermined range, e.g. if the RPM of the spin motor 36 is outside a previously set predetermined RPM range, information indicating that trouble now occurs in the operating part 80 is transmitted from the unit controller UC through the cell controller CC, the spin controller, the bake controller and the like to the main controller MC. The main controller MC then issues an alarm to the main panel MP, and the control equipment 81 takes action such as the stop of the operation of the operating part 80, as required. On the other hand, the operating information about the operating part 80 detected by the detector 82 is transmitted as an operating information signal from the unit controller UC to the data controller DC irrespective of whether or not the operating state of the operating part 80 is outside the previously set predetermined range. Specifically, an analog output signal from the detector 82 is transmitted to the data controller DC.

An obtaining part 83 in the data controller DC accumulates such operating information signals transmitted from the unit controller UC to obtain the operating state transition information about the operating part 80. The term “operating state transition information” refers to information constructed as a result of the accumulation of the operating information signals and indicating a change with time in operating state of the operating part 80. The obtaining part 83 then judges whether or not the operating state transition information is abnormal. Specifically, the obtaining part 83 compares the operating state transition information obtained as mentioned above with a pattern of the change with time in normal operating state of the operating part 80 which is stored in a storage part 85 in the data controller DC to thereby judge whether or not the operating state transition information is abnormal.

If the obtained operating state transition information deviates by a predetermined amount or more from the pattern of the change with time in normal operating state as a result of the comparison, the obtaining part 83 judges that the operating state of the operating part 80 is abnormal, and a teaching part 84 transmits a warning signal indicating that the operating state of the operating part 80 is abnormal to the main controller MC. For example, if the obtained change with time in RPM of the spin motor 36 deviates by a predetermined amount or more from the pattern of the change with time in normal operating state, it is judged that the operating state of the spin motor 36 is abnormal, and the warning signal so indicating is transmitted to the main controller MC. If the operating state of the operating part 80 is also outside the above-mentioned previously set predetermined range, the information indicating that trouble now occurs is transmitted to the main controller MC without waiting for the analysis of the data controller DC. In other words, the warning signal is transmitted from the teaching part 84 to the main controller MC when the change with time in operating state deviates from the normal pattern, although not regarded immediately as the occurrence of trouble, so that there is a possibility of the occurrence of a failure in the operating part 80 in the near future.

On the other hand, if the obtained operating state transition information does not deviate by the predetermined amount or more from the pattern of the change with time in normal operating state, the obtaining part 83 judges that the operating state of the operating part 80 is normal. In this case, the warning signal, of course, is not issued from the data controller DC.

In this preferred embodiment, the teaching part 84 transmits an alarm code as the warning signal to the main controller MC. A database providing a correspondence between alarm codes and the types of operating state transition information is previously stored in the storage part 85 of the data controller DC. The teaching part 84 searches the database to thereby determine which alarm code is to be issued. For example, when the type of operating state transition information is the RPM of the spin motor 36, the teaching part 84 transmits the alarm code “101” to the main controller MC.

When the main controller MC receives the alarm code as the warning signal from the teaching part 84, an warning issuing part 87 in the main controller MC issues a warning that there is a possibility of the occurrence of a failure in the operating part 80. Specifically, a storage part 88 in the main controller MC stores therein an alarm file 89 providing a one-to-one correspondence between alarm codes and pieces of treatment information. A search part 91 in the main controller MC searches the alarm file 89 to obtain a piece of treatment information corresponding to the alarm code transmitted from the teaching part 84. Then, the warning issuing part 87 issues the warning.

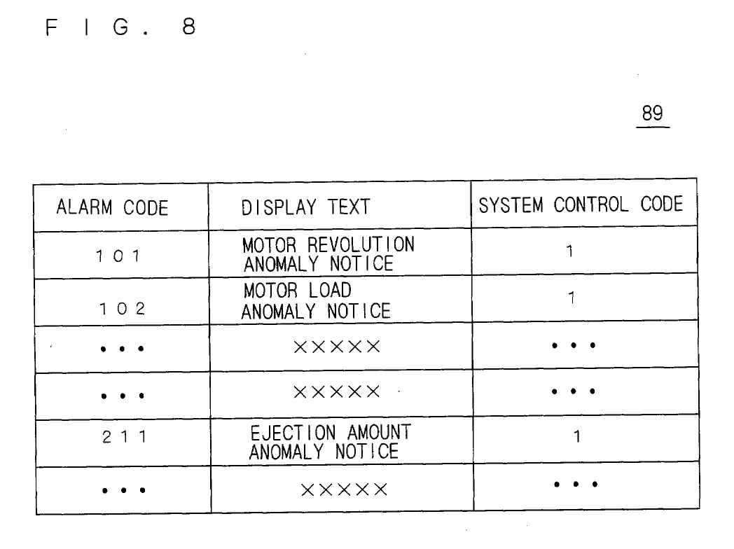

FIG. 8 shows an example of the alarm file 89. In the example shown in FIG. 8, the treatment information includes “Display Text” and “System Control Code” each of which is in one-to-one correspondence with the alarm codes. “Display Text” refers to a text message displayed when the warning is issued. “System Control Code” refers to a code indicating the details of control to be effected by the main controller MC. As an example, when the main controller MC receives the alarm code “101” as the warning signal from the teaching part 84, the search part 91 in the main controller MC searches the alarm file 89 to obtain the display text “motor revolution anomaly notice” and the system control code “1” both corresponding to the alarm code “101.” The warning issuing part 87 displays the display text “motor revolution anomaly notice” on the main panel MP, and reports an operating anomaly of the spin motor 36 to the host computer 100 in accordance with the system control code “1.” Similarly, when the main controller MC receives the alarm code “211” as the warning signal from the teaching part 84, the search part 91 in the main controller MC searches the alarm file 89 to obtain the display text “ejection amount anomaly notice” and the system control code “1” both corresponding to the alarm code “211.” Then, the warning issuing part 87 displays the display text “ejection amount anomaly notice” on the main panel MP, and reports a resist ejection pump operating anomaly to the host computer 100 in accordance with the system control code “1.”

Of course, the system control code may be set at other than “1.” For instance, a code setting which stops the operation of the operating part 80 of interest may be made. In this preferred embodiment, the obtaining part 83 and the teaching part 84 are processors implemented by causing the CPU of the data controller DC to execute analysis software 86 stored in the storage part 85, and the warning issuing part 87 and the search part 91 are processors implemented by causing the CPU of the main controller MC to execute software (not shown) stored in the storage part 88.

This enables the main controller MC of the substrate processing apparatus RF to collectively manage the information about the operating anomalies of the operating part 80 not only when trouble now occurs in the operating part 80 but also when there is a possibility of the occurrence of a failure in the operating part 80 in the near future. Then, issuing the warning that there is a possibility of the occurrence of a failure in the operating part 80 from the main controller MC to the main panel MP enables an operator working near the substrate processing apparatus RF to recognize the failure notice immediately, thereby allowing rapid troubleshooting and maintenance support. Reporting the waning that there is a possibility of the occurrence of a failure in the operating part 80 from the main controller MC to the host computer 100 enables the host computer 100 to collectively manage the information about the operating anomalies of the operating part 80.

Although the preferred embodiment according to the present invention is described hereinabove, the present invention is not limited to the above-mentioned specific embodiment. For example, the data controller DC is provided in the substrate processing apparatus RF in the above-mentioned preferred embodiment, but the present invention is not limited to such an arrangement. The data controller DC may be provided outside the substrate processing apparatus RF. As an example, the data controller DC may be provided in the data collection server 200. In such a case, if the obtained operating state transition information deviates by a predetermined amount or more from the pattern of the change with time in normal operating state, the warning signal indicating that the operating state of the operating part 80 is abnormal is also transmitted from the data controller DC to the main controller MC. This produces effects similar to those of the above-mentioned preferred embodiment.

The operating information about the operating part 80 monitored by the data controller DC, of course, is not limited to that described in the above-mentioned instance, but may include operating information about all of the drivers, mechanical parts and the like included in the substrate processing apparatus RF.

Additionally, the construction of the substrate processing apparatus RF according to the present invention is not limited to that shown in FIGS. 1 through 4. However, various modifications may be made to the construction of the substrate processing apparatus RF if a transport robot circulatingly transports a substrate W to a plurality of processing parts whereby predetermined processes are performed on the substrate W.

While the invention has been described in detail, the foregoing description is in all aspects illustrative and not restrictive. It is understood that numerous other modifications and variations can be devised without departing from the scope of the invention.

What is claimed is:

1. A system for processing a substrate, comprising:
a substrate processing apparatus for performing a predetermined process on a substrate; and
a monitoring controller for monitoring the operation of said substrate processing apparatus, said substrate processing apparatus and said monitoring controller being connected to each other,
said substrate processing apparatus including
an operating part for performing an operation for said predetermined process,
a detector for detecting operating information about said operating part, and
a main controller for managing the operation of said operating part,
said monitoring controller including
an obtaining part for obtaining operating state transition information indicating a change with time in operating state of said operating part, based on the operating information about said operating part transmitted from said detector, and
a teaching part for transmitting a warning signal indicating that the operating state of said operating part is abnormal to said main controller when said operating state transition information is abnormal.

2. The system according to claim 1, wherein
said main controller includes a warning issuing part for issuing a warning indicating that there is a possibility of the occurrence of a failure in said operating part when receiving said warning signal from said teaching part.

3. The system according to claim 1, wherein
said warning signal includes an alarm code corresponding to the type of said operating state transition information, and
said main controller includes
a storage part for storing therein an alarm file providing a one-to-one correspondence between a plurality of alarm codes and a plurality of pieces of treatment information, and
a search part for searching said alarm file to obtain a piece of treatment information corresponding to said alarm code transmitted from said teaching part.

4. A substrate processing apparatus for performing a predetermined process on a substrate, comprising:
an operating part for performing an operation for said predetermined process;
a detector for detecting operating information about said operating part;
a main controller for managing the operation of said operating part; and
a monitoring controller for monitoring the operation of said substrate processing apparatus, said monitoring controller including
an obtaining part for obtaining operating state transition information indicating a change with time in operating state of said operating part, based on the operating information about said operating part transmitted from said detector, and
a teaching part for transmitting a warning signal indicating that the operating state of said operating part is abnormal to said main controller when said operating state transition information is abnormal.

5. The substrate processing apparatus according to claim 4, wherein
said main controller includes a warning issuing part for issuing a warning indicating that there is a possibility of the occurrence of a failure in said operating part when receiving said warning signal from said teaching part.

6. The substrate processing apparatus according to claim 4, wherein
said warning signal includes an alarm code corresponding to the type of said operating state transition information, and
said main controller includes
a storage part for storing therein an alarm file providing a one-to-one correspondence between a plurality of alarm codes and a plurality of pieces of treatment information, and
a search part for searching said alarm file to obtain a piece of treatment information corresponding to said alarm code transmitted from said teaching part.

7. A program executed by a computer provided in a substrate processing apparatus to thereby cause said substrate processing apparatus to operate as the substrate processing apparatus defined in claim 4.

8. A computer-readable recording medium having stored thereon the program defined in claim 7.
